(19) United States
(12) Patent Application Publication
(10) Pub. No.: US 2022/0044313 A1
(43) Pub. Date: Feb. 10, 2022

(54) HYBRID ELECTRONIC PAYMENT PROCESS FOR CHARGE ACCOUNT

(71) Applicant: CGI FEDERAL INC., Fairfax, VA (US)

(72) Inventors: Elizabeth D. COX, Falls Church, VA (US); Ashley WOULFIN, Marietta, GA (US); Clayton Gregory GAVIN, Fairfax, VA (US)

(73) Assignee: CGI FEDERAL INC., Fairfax, VA (US)

(21) Appl. No.: 16/985,882

(22) Filed: Aug. 5, 2020

(51) Int. Cl. G06Q 40/02; G06Q 20/22; G06Q 20/24

(52) U.S. Cl. CPC G06Q 40/02; G06Q 20/24; G06Q 20/227

(57) ABSTRACT

A computer is to store information indicating a plurality of validation information in form of threshold controls to perform electronic payment processes corresponding to electronic charge account purchase transactions, respectively. In response to input of charge account purchase information indicating a forecast of a charge account purchase, generate an electronic obligation transaction resulting from a plurality of verifications of the charge account purchase information based on the plurality of threshold controls; and in response to receipt of a first electronic charge statement including a plurality of statement charge lines, each statement charge line indicating information of a completed charge account purchase, providing a settable payment authorization on a statement charge line by statement charge line basis of the plurality of statement charge lines, resulting from a hybrid payment model setting, to authorize a payment corresponding to a completed charge account purchase in a statement charge line among the statement charge lines.

### BACKGROUND

Charge account transactions continue to be a prevalent method of making purchases by large organizations, particularly purchases of consumer type items needed on an immediate basis that do not meet a particular threshold. Organizations want to maintain control over the continuously growing number of these transactions, but they are forced into a situation of ‘dual budgeting’, which requires them to make a decision between setting aside temporary funding for statement payment upon receipt or delaying payment for reconciliation, which risks the accrual of penalties and additional fees for late payment.

### BRIEF DESCRIPTION OF THE DRAWINGS

FIG. 1 is a diagram of a computer system, according to an example of the disclosure.

FIG. 2 is a functional block diagram illustrating an operation flow in a computer system, according to an example of the disclosure.

FIGS. 3A-1 to 3A-3 are diagrams of databases, according to an example of the disclosure.

FIG. 3B is a data structure diagram of control databases in the computer system, according to an example of the disclosure.

FIG. 4 shows a top level flow of processing credit card transactions, according to an example of the disclosure.

FIG. 5 is a flow chart of obligation processing for a credit card transaction with computer system controls, according to an example of the disclosure.

FIGS. 6A-6B, 7A-7B, and 8 are flowcharts of payment processing models including a hybrid payment processing of a credit card statement, according to an example of the disclosure.

FIG. 9 is a functional block diagram of a computer, which is a machine, for implementing examples of the disclosure.

### DETAILED DESCRIPTION

Reference will now be made in detail to examples which are illustrated in the accompanying drawings. In this regard, the examples may have different forms and should not be construed as being limited to the descriptions set forth herein. In order to further clearly describe features of the examples, descriptions of other features that are well known to one of ordinary skill in the art may be omitted.

The singular forms “a,” “an” and “the” are intended to include the plural forms as well, unless the context clearly indicates only a singular form.

The term of “and/or” includes a plurality of combinations of relevant items or any one item among a plurality of relevant items.

The term “at least” preceding a listing of items denotes one or any combination of the items in the listing.

The terms “comprise(ing),” “include(ing),” and “have(ing)” when used in this specification, specify the presence of stated features, functions, processes/operations, elements, and/or components, but do not preclude the presence or addition of one or more other features, functions, processes/operations, elements, components, and/or groups thereof.

In the specification, when an element is “coupled,” “linked” or “connected” to another element, the elements may not only be “directly connected,” but may also be “connected” via another element there between. The “coupling” may be by way of data communication. Also, when a described concept “includes” an element, the described concept may further include another element instead of excluding the other element, unless otherwise differently stated.

A charge account may be an electronic account indicating a monetary value or credit (chargeable amount) to conduct a purchase of a goods and/or a service from a vendor for a charge amount (price) (a charged purchase). A payment corresponding to the charge amount may be made based on an electronic transfer of money. A charge account purchase may be by way of using a physical card (i.e., credit card) and/or card-less through a computing device.

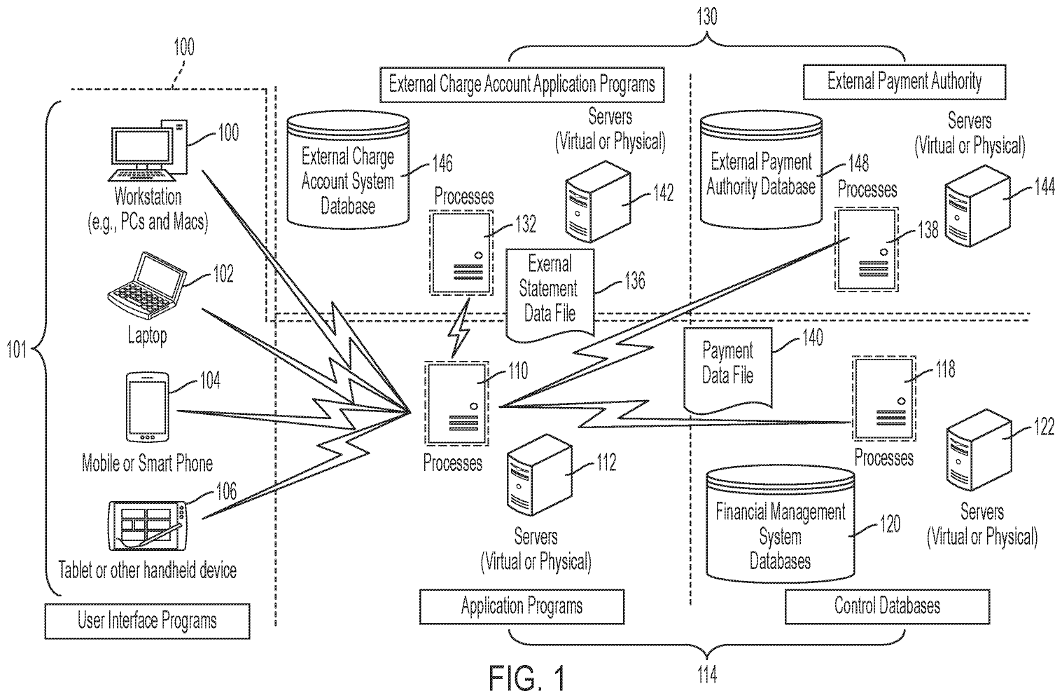

FIG. 1 is a diagram of a computer system, according to an example of the disclosure. Referring to FIG. 1, a computer system 100 may include a plurality of computing devices 101, such as workstation 100, a laptop 102, mobile or smartphone 104, or a tablet or other handheld device 106, which implement a user interface (UI) side program (software) and a computer system 114. The computing devices 101, respectively, may interact, via a suitable UI program, with the computer system 114 implementing a computerized financial manager.

The financial management computer system 114 may electronically record charge account activity after completion of a charge account purchase. At a time that an electronic charge statement (referred to as statement) of charge account purchases (charges, namely credit and/or debit charges) is received from an external charge account provider (bank or lender) computer system (external computer system) 130, the financial management computer system 114 transforms the statement to create charge transactions corresponding to the charge account purchases indicated in the statement to represent the charge account purchases in the system 114 for electronic processing and to provide electronic authorization for payment of the charge account purchases. As part of the electronic processing of the statement, the financial management computer system 114 is to provide for automatic controls based upon various control settings, and reconciliation as part of payment processing for the credit card charges for identification of disputed charges or assignment to budgetary accounts.

The time and effort required for a manual reconciliation can be significant, which requires each charge account user to review the user's own charge account purchase and compare the charge account purchase with an invoice from the vendor, or with a personal ledger of charge account purchases that the user keeps.

A financial management system, may allow for automated reconciliation based on internal controls and thresholds and allow an authorized user to choose whether to pay a charge statement before reconciliation or to hold payment until after reconciliation. Organizations who choose to pay upon receipt of the charge statement may be forced into a situation of ‘dual budgeting’ that requires an organization to tie up a portion of the annual budget in a suspense account to make funding available for statement payment upon receipt of the charge statement. The amount in the suspense account should be equal to the total of charges anticipated or forecasted for a period of time, for example, a year, since there may not an anticipated timeframe during which reconciliation should occur. This means organization's financial statements may be over (or under) stated until reconciliation can occur and that a complex series of transfer postings for general ledger clean-up is needed for clear traceability after reconciliation. Organizations who choose to pay a charge statement after reconciliation by a user risk the accrual of penalties and additional fees for late payment and may incur expense write-downs in case of the user being an employee and employee turnover occurs prior to reconciliation.

What is needed is a financial management system that properly accounts for the individual transactions by obligating the funds at the time of purchase, but allowing a payment authorization at the charged purchase transaction level (statement line level) whether to pay before or after reconciliation. This hybrid model would reduce the amount of funding tied up in suspense account processing so it becomes available for business operations more quickly, reduce the need for complex general ledger posting and reversal models to maintain the traceability needed for auditable financial statements, and reduce the risk of unforeseen late payment penalties and fees. It will also create greater efficiencies within the organization by reducing the user's need to manually reconcile individual charged purchases to the statement, allowing the user to focus on the mission of the organization instead of the administration of their charge purchases.

For reference convenience, a charge purchase may be referred to as a credit card purchase, which may be completed electronically without a card being present or by way of a computing device in form of mobile computing device payment and digital wallet service through a software application.

For example, a computer system may process credit card transactions within the computer system, for example, a financial management system where credit card purchases may be automatically reconciled by way of credit card statements to the proper budget accounts based on credit card number. Instead of requiring an entire statement to be processed at once, the computer system allows for suspense account processing for advance payment and transaction by transaction reconciliation after the transaction level controls associated with internal financial limits implemented by the computer system, which are independent of the credit card company issuer limits, are applied.

The financial management computer system allows for credit card transactions to be captured prior to the actual transaction with the bank, in the form of a requisition or an obligation, and subjected to the controls of the financial management computer system. The financial management computer system may be used by any organization seeking to track and control purchases generally made via credit card, regardless of whether this is a corporate, non-profit organization, or government agency. The financial management computer system provides several levels of control for managing credit card transactions while also ensuring that the credit card transactions confirm with the standard set of budget, financial planning, and general ledger controls used for standard financial transactions.

The new hybrid payment model combines the two models of payment immediately upon receipt of the statement from a suspense account and payment after reconciliation from the budget account. An example benefit of the hybrid payment model is the organization does not have to tie up its funding in suspense budgets to disburse payments for payment of credit card statements. Suspense account model places a burden on the organization because, when funding is set aside in suspense accounts, the funding is not able to be spent. With hybrid payment model, funds allocated to suspense budgets may be freed up earlier for use for other things. At fiscal period-end, this is particularly important because organizations need an accurate accounting of their available budget to have confidence that they can complete all their planned spending and prepare their financial statements by required due dates. In addition to having to budget less money for credit card purchases, the hybrid payment model may facilitate prompt payment of statements using as much of the reconciled funds as possible. This may allow organizations to pay credit card statements in a timely manner so they can take advantage of favorable terms from their financial institution in the form of discounts and rebates. The hybrid payment model may also reduce the time spent on reconciliation of credit card statements to financial system transactions due to known purchases being automatically reconciled and then automatically paid much earlier in time that the payment after reconciliation from the budget account model.

Referring to FIG. 1, the computer system 114 may include financial management application processes 110 hosted on one or more virtual or physical servers 112 which access data within a database server system 116 where processes 118 access financial management system databases 120 stored on one or more virtual or physical servers 122, to thereby implement a financial management system 114. computing devices 101 can be communicationally coupled to the financial management system 114 by way of processes 110 directly or via a packet-switched network, such as the Internet. Typically, a company (or possibly a government agency) will have a multitude of such computing devices 101, allowing each authorized employee access to the processes 110.

The financial management computer system 114 is to electronically verify enforcement of rules to process electronic credit card purchase transactions input to the computer system. At least one server 112 is to communicatively couple to a plurality of computing devices 101, the at least one server 112 is integrated with an external charge account computer system 130 and the at least one server 112 includes at least one processor configured to execute at least one process to store, using financial management system databases 120, information indicating a plurality of validation information to process the electronic credit card purchase transactions associated with information identifying credit cards usable to initiate the electronic credit card purchase transactions.

The computer system 114 communicationally couples with an external charge account computer system 130 implementing a computerized payment card manager to provide payment card services to the computer system 114. The payment card services may include, for example, external credit card issuer processes 132 to transmit electronic external charge account provider statements (external statements) 136 as well as external payment authority processes 138 to authorize the disbursement of funds by way of payment information 140 indicating payment amounts owed as indicated on the external statements 136.

The external credit card issuer processes 132 may be hosted on one or more virtual or physical servers 142 which communicationally couple to an external credit card system database 146 storing the external statements 136, and the external payment authority processes 138 may be hosted on one or more virtual or physical servers 144 which communicationally couple to an external payment authority database 148 storing the payment request information 140. The communications among the computing devices 101, the computer system 114 and the external computer system 130 may be via electronic file transfer or other media by way of direct connection or connections over a packet-switched network, for example, the Internet, all of which are also within the architecture contemplated by the system described herein.

Referring to FIG. 1, when a credit card is set up in the financial management system 114, the credit card may be assigned to an individual card holder, and it is indicated whether the card holder will charge to a suspense account, will be required to reconcile any purchases prior payment of the credit card statement, or will be allowed to follow a ‘hybrid model’ of transaction reconciliation, which allows the card holder to indicate which credit card purchase, or a type of credit card purchase, should be paid immediately upon receipt of a credit card statement including a credit card purchase transaction corresponding to the indicated credit card purchase, or corresponding to the type of credit card purchase, and which credit card purchase to first reconcile before payment upon receipt of the credit card statement.

Initially, a credit card purchase to be made is deemed an obligation before occurrence of a credit card purchase transaction corresponding to the credit card purchase, so that information of the credit card purchase is recorded in the financial management system 114 as an credit card purchase obligation, which may indicate reserving of the required funds in a corresponding budget in advance of receiving the credit card purchase transaction by way of a credit card statement. Each credit card purchase obligation is subjected to the electronic controls implemented in the financial management system 114 for funds availability and security as well as controls for internally managing purchase limits for the individual card holder. Credit card purchases passing the controls are recorded using the appropriate general ledger accounts for the type of purchase.

When the external statement 136 is received from the external credit card issuer processes 132, the financial management system 114 automatically reconciles the credit card obligations with the individual credit card statement credit card purchase transactions based on information indicating internal thresholds and controls. The financial management system 114 performs the necessary updates to the financial management system databases 120, including, for example, budget, financial planning, project, and general ledger updates and the liquidation of open credit card purchase transactions to be paid, to indicate that processing of a credit card purchase transaction has been completed. The system 114 generates information indicating authorization of a payment for the total of all automatically reconciled credit card obligations with individual payment lines tracing back to the original credit card obligation to liquidate that charge.

The system 114 flags any discrepancies raised by the internal thresholds and controls for user intervention. The system 114 also allows cardholders to identify disputes and track the dispute correspondence with the card issuer. Payment for individual credit card transactions in a credit card statement may not be processed until the dispute is resolved or the discrepancy is addressed.

The system 114 tracks each credit card and its relevant information including card number, cardholder, issuing company, expiration date, etc. It also assumes that the system 114 allows internal credit limits including billing cycle limit and single purchase limits to be assigned for each credit card or a group of cards. These financial management system limits are enforced independently of any credit limits imposed by the credit card issuing company, which for convenience are called issuer limits, at the time when a credit card purchase obligation transaction is to be processed and approved to be recorded. In addition to limits, the financial management system 114 allows a default accounting distribution or default account codes to be assigned to each card to serve as a suspense account where the effects of the obligation transaction are recorded if a budget account is not provided by the card holder. Finally, the financial management system 114 allows such anticipated credit card purchase transactions to be recorded in the system as credit card purchase obligations prior to their actual identification on a credit card statement. As these credit card purchase obligation transactions are recorded, they are subjected to the financial controls, which may include budget, financial plan, and project funds availability checks, and the security controls, which may include user ID and password checks as well as secondary approvals based on the transaction dollar amount and/or the type of goods to be purchased.

The financial management system 114 implements an automated reconciliation function that occurs for each billing cycle when external statement file 136 is received from the credit card issuer processes 132. The external statement file 136 contains information indicating details of the individual credit card purchase transactions for one or more, or a set of, credit card holders within an organization, and it is automatically loaded into the financial management system databases 120 to be stored for reconciliation. For example, the external statement 136 may be transformed and stored in the reconcilable statement database 332. The original external statement 136 may be retained for audit and future reference purposes, and the reconciliation of reconcilable statement 332 is independent so actions taken on the reconcilable 332 can be verified against external statement 136. A reconciliation may result in a credit card purchase being authorized for payment or being marked for dispute. The organization may require that the credit card holder manually reconcile the entire reconcilable statement 332 to the purchase obligations prior to payment or to allow the financial management system 114 to perform an automatic reconciliation, which would pay any individual charge account purchase transactions that fail the automated reconciliation controls against a suspense account and delay reconciliation for post payment.

An organization may require the ability to minimize the amount of funding reserved in the suspense account while still also driving efficiencies by reducing card holder administration of their credit card purchases. Instead of requiring the organization to process an entire reconcilable statement 332 to the suspense account or to reconcile an entire reconcilable statement 332 prior to payment, the financial management system 114 implements a third option whereby the organization can choose to allow a credit card holder to indicate whether to manually or automatically reconcile at the individual credit card purchase level. If no action is taken by the card holder to manually reconcile the individual transactions of the reconcilable statement 332, thereby liquidating the credit card purchase obligations with the individual corresponding payments, the system 114 will attempt to automatically reconcile the individual statement transactions. Only in the case where the automatic reconciliation of the individual transactions of the credit card statement fails the internal system controls will the system 114 process payment against the suspense account for post-payment reconciliation.

When the payment authorizations are generated and processed for each individual credit card purchase transaction of a reconcilable statement 332, the budget unique identifiers are first taken from the financial transaction database 306 that reference back to the budget database 304. This allows the appropriate budgets, projects, general ledger accounts, and financial plans to be updated as the payments and subsequent disbursements are processed. If the reconciliation has not occurred at the time of payment, the accounting codes are taken from the credit card set-up information, and then the payment is processed to the suspense account, and the obligation remains open until the credit card transaction is reconciled to an obligation.

If a credit card transaction is reconciled after the payment has been made, the user has the opportunity to reverse the charges to the suspense accounting codes (or override the default codes) associated with the payment transaction by reconciling the credit card statement transaction to an open credit card purchase obligation. The system 114 backs out the updates associated with the original suspense accounting codes and performs the updates needed for the new accounting codes. The back-out and re-do of the updates ensures that the proper budgets, financial plans, projects, and general ledger account balances reflect the true accounting codes of the credit card transaction and provide traceability of funds between the original and new accounting codes. The mapping of the payment to an obligation also releases the funds reserved in the suspense account, providing a more accurate financial position for the organization.

The financial system databases 120 include a combination of control databases, transactional databases, and reference databases to implement a plurality of electronic verifications for a charge purchase. The financial system databases 120 may store reference data on valid charge accounts and electronic reconcilable statement data 332 , and the financial management system databases 120 are structured to capture the additional data of the statement hybrid payment option to the charge account to direct the financial management system 114 how to process electronic reconcilable statements 332 for the hybrid payment model. The external charge account computer system 130 may not have a record of the internal financial management system's 114 payment transaction identifier at the individual purchase transaction level, but only at the external statement 136 level when the external statement 136 is paid. The individual purchase may be independently tracked by the external charge account computer system 130, and the financial management control system 114, and respective independent reconciliation may ensure there is constructively a match between the two.

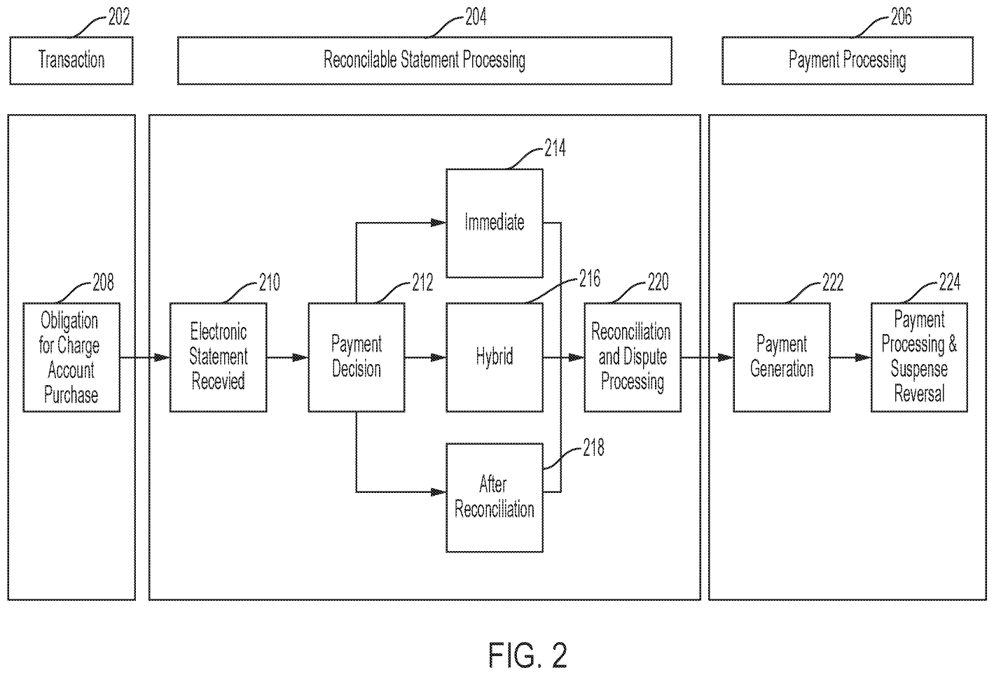

FIG. 2 is a functional block diagram illustrating an operation flow in a computer system, according to an example of the disclosure.

Referring to FIG. 2, the operations of the financial management system 114 may be divided into three primary phases of a credit card purchase: the transaction processing 202, the statement processing 204, and the payment processing 206. At operation 208, the obligation is processed for the credit card purchase. For example, an employee of the organization, which may be a corporation or government agency, uses the financial management system 114 to record a credit card purchase to be made at some point with a credit card issued by an external credit card provider. The credit card purchase transaction may be been made with a vendor, either in person or electronically, such as using a vendor web site. The vendor notifies the external credit card provider computer system 130 of the transaction. The external credit card provider computer system 130 aggregates purchases from vendors into an external statement 136, which at operation 210 is transmitted to the organization via electronic file transfer or other electronic transmissions. At operation 212, the financial management computer system 114 determines a payment process type setting for how credit card statement payments will be generated. At operation, 214, the financial management system 114 may allow immediate payment of the full statement balance against a suspense account, at operation 218, the system 114 is to require reconciliation of credit card purchase transactions of a statement back to obligation accounting codes prior to payment of the statement balance, or at operation 216, the system 114 may allow a hybrid payment model to pay any reconciled individual credit card purchase transactions (referred to as statement lines) using the obligation accounting codes and any unreconciled lines using the suspense account. After statement processing 204 occurs, payment processing 206 occurs, where at operation 220 the payment is generated for the reconciled statement balance net of any disputed transactions, and at operation 222 the payment is authorized 24. At operation 224, in case of performing reconciliations of transactions on a statement by statement basis (after reconciliation processing 218), or performing reconciliation of a transaction line during the translation line by transaction line of a statement basis (hybrid payment processing 216), such the transaction(s) are reconciled to the obligation accounting codes after the statement or the transaction line (as the case may be) is paid, the payment line specific to that transaction line in the statement is reversed from the suspense account and charged to the correct obligation accounting codes.

FIGS. 3A-1, 3A-2 and 3A-3 are diagrams of databases, according to an example of the disclosure. The financial management system 114 operates in an environment having a database model as shown in FIGS. 3A-1, 3A-2 and 3A-3, where a database or system of databases provide the support and store for credit card transaction processing.

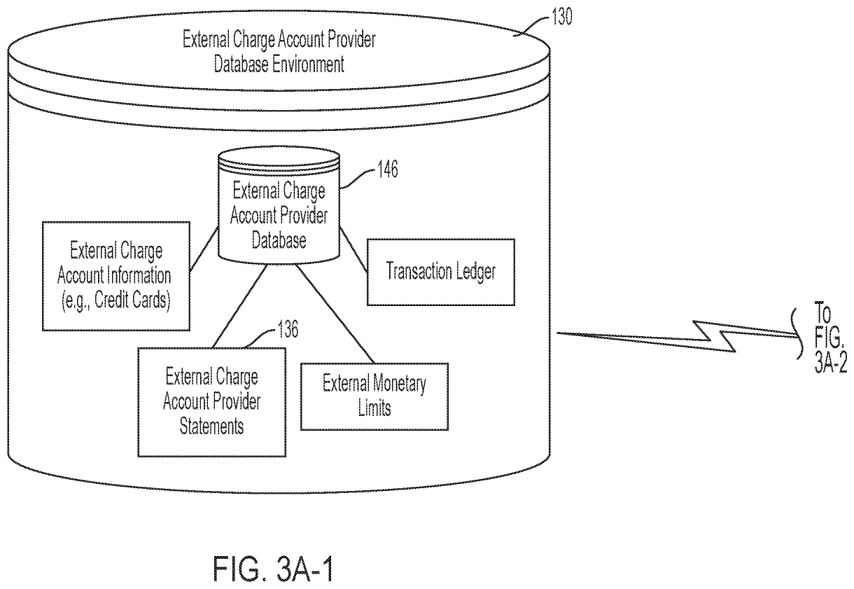

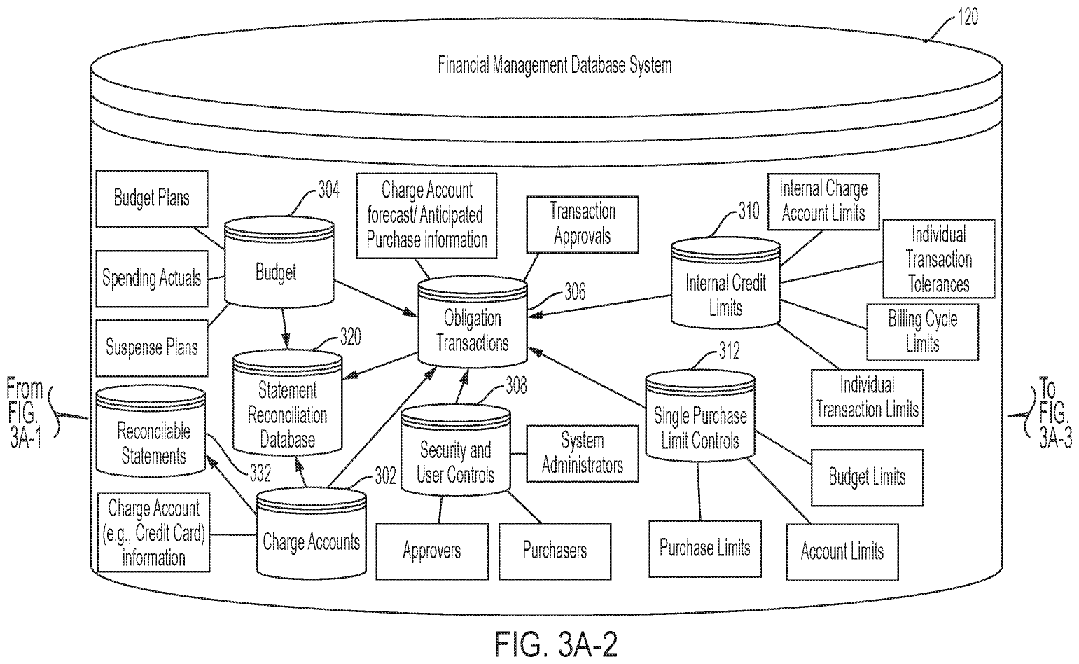

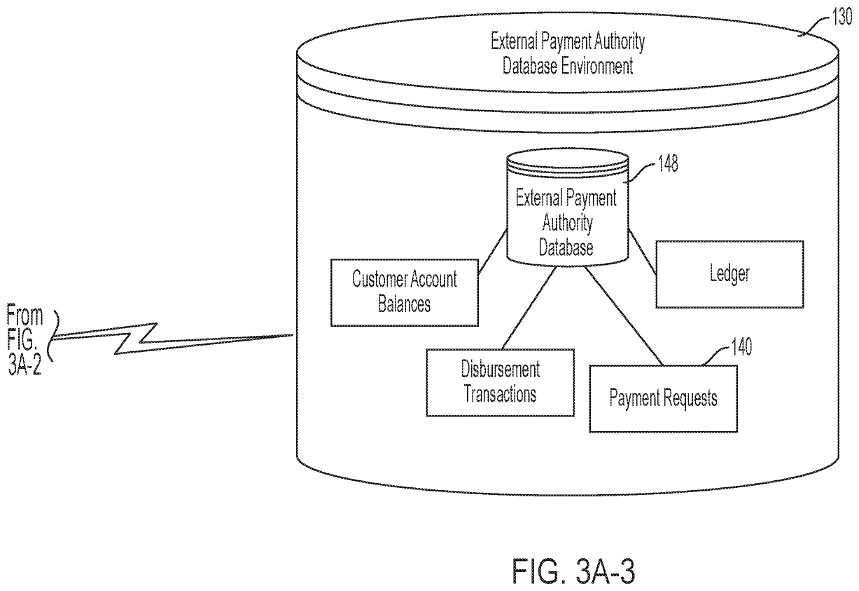

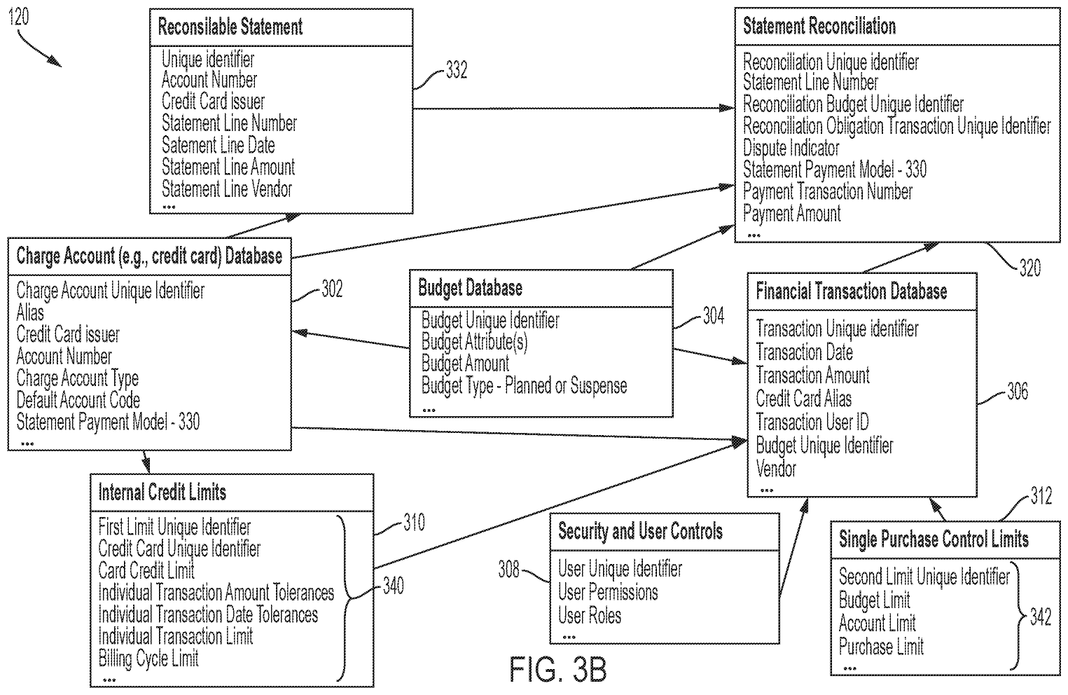

Referring to FIG. 3A-1, the external credit card provider system 130 stores an external credit card system database 146, which may store information identifying credit cards, for example, by a credit card number, an external statement 136, information indicating monetary limits by a credit card provider on a credit card (external monetary limits) and a transaction ledger of credit card purchases. The external statement 136 may indicate a unique identifier, a credit card account number, name of a credit card issuer, a statement line number, statement line date, statement line amount, and statement line vendor.

Referring to FIG. 3A-3, the external payment authority database 148 may store information indicating payment disbursement authorization 140 received from the financial management system 114, a customer account balance, a ledger and information indicating disbursement transactions.

Referring to FIG. 3A-2, the financial management system databases 120 include a credit card database 302, a budget database 304, a financial transactions database 306, security and user control database 308, internal (financial management computer system 114) credit limits database 310, single purchase limit controls database 312, and a statement reconciliation database 320.

FIG. 3B is a data structure diagram of control databases in the computer system, according to an example of the disclosure.

The budget database 304 includes a budget unique identifier, a budget attribute, a budget amount and a budget type settable to a planned budget or a suspense account budget. A budget attribute may be a fund code, organization code, object code, program or project code, or other code that, when combined, make up a unique budget account. This unique budget account is identified by the unique budget identifier. The budget database 304 includes budget plans defined by authorized budget account codes and specifying available money to be spent, suspense plans defined by authorized suspense account codes for use when budget alignment cannot be determined at the time of credit card transaction processing, and spending actuals resulting from credit card transaction processing against a specific budget plan, a suspense account, or resulting from transfer from a suspense account to a specific budget plan after transaction reconciliation.

A credit card database 302 includes information indicating a credit card unique identifier, an alias, a credit card issuer, an account number, a credit card type, and a statement payment model 330. A credit card database 302 is created to store credit cards data, such as card identifiers, authorized spender, and alias to mask card identifiers from other system users, and spending actual processed against an individual credit card. The statement payment model 330 is settable to any one of the three payment models of immediate payment of a full statement balance against a suspense account, reconciliation of credit card purchase transactions of a statement back to obligation accounting codes prior to payment of the statement balance, or a hybrid payment model to pay any reconciled individual credit card purchase transactions (referred to as statement lines) using the obligation accounting codes and any unreconciled lines using the suspense account.

An internal credit limits database 310 stores information indicating a first limit unique identifier 340. The first limit unique identifier 340 corresponds to a plurality of internal control limits including an internal credit card limit, internal individual transaction amount tolerance (threshold), internal individual transaction date tolerance (threshold), internal individual transaction limit, and internal billing cycle limit. The term ‘internal’ refers to control information settable in the financial management system 114. The internal credit limits database 310 is to establish overall credit card limits, individual transaction limits to create a ‘not to exceed’ amount for individual transactions, individual transaction tolerances used for reconciliation, and billing cycle limits.

A single purchase control limits database 312 stores information indicating a second limit unique identifier 342. The second limit unique identifier 342 further corresponds to a plurality of internal control limits including a budget limit, account limit and purchase limit. The single purchase limits database 312 is to establish controls that apply to all transactions, including credit card transactions, such as budget limits, purchase limits, and account limits. A single purchase limit may be associated with a user. An individual transaction limit is associated with a charge account, for example, a credit card. A user purchasing something with a credit card may be controlled by both limits.

A security and user control database 308 stores information indicating a user unique identifiers, a user permission and a user role. The security and user controls database 308 identifies system administrators who manage all reference data and are accountable for system integrity and that designates users with permissions for purchasing and approving transactions.

A financial transaction database 306 stores information indicating a transaction unique identifier, a transaction date, a transaction amount, a credit card alias, a transaction user ID, a budget unique identifier corresponding to the budget unique identifier of the budget database 304, and a vendor. A financial transaction database 306 stores individual credit card purchase transactions and the approvals applied to each transaction by a user authorized in the security and user controls database to cause a payment transaction. Therefore, the financial transaction database 306 stores information of a financial transaction by indicating both an obligation that results in a corresponding payment transaction.

The financial management system 114 electronically integrates with the external card provider system 130, which may include the external credit card issuer processes 132 with the external credit card system database 146, and external payment authority processes 138 with the external payment authority database 148. The external computer system 130 provides an external credit card system database 146 of information indicating external controls that define authorized credit cards, authorized card users, transaction and billing cycle monetary limits, and external statements 136, where information indicating external controls are implemented independent of information indicating controls in the financial management computer system 114. The external credit card system database 146 also contains a transaction ledger that identifies individual credit card transactions received from points of purchase that are aggregated into credit card statements at the end of each billing cycle. These external statements 136 are transmitted electronically to the financial management system 114 for each billing cycle, where they are loaded in into the reconcilable statement database 332 of the financial management system databases 120 in the financial management system 114. According to another example, the external statements 136 may be loaded in form of an statement object in the charge accounts database 302. The financial management system 114 provides an electronic notification of disputed credit card statement lines to the external credit card system 130, identifying the credit card number, disputed transaction, disputed amount, and reason for the dispute.

Referring to FIGS. 3A-1, 3A-2, and 3B, although the lead lines among the control databases 120 are illustrated to be directional for describing the examples, it is to be understood that the data of the databases 120 may be associated with each other and accessible among each other in any combination.

The financial management system 114 electronically integrates with the external computer system 130, which may include an external credit card issuer process 132 with an external credit card system database 146, and an external payment authority process 138 with an external payment authority database 148. The financial management system 114 sends a payment disbursement authorization 140 to an external payment authority processes 138 of a bank or the U.S. Treasury. This payment disbursement authorization 140 may be sent electronically by the financial management system 114, via electronic file transfer, or manually, via check delivered to the external credit card provider, who submits the check to the payment authority in exchange for payment.

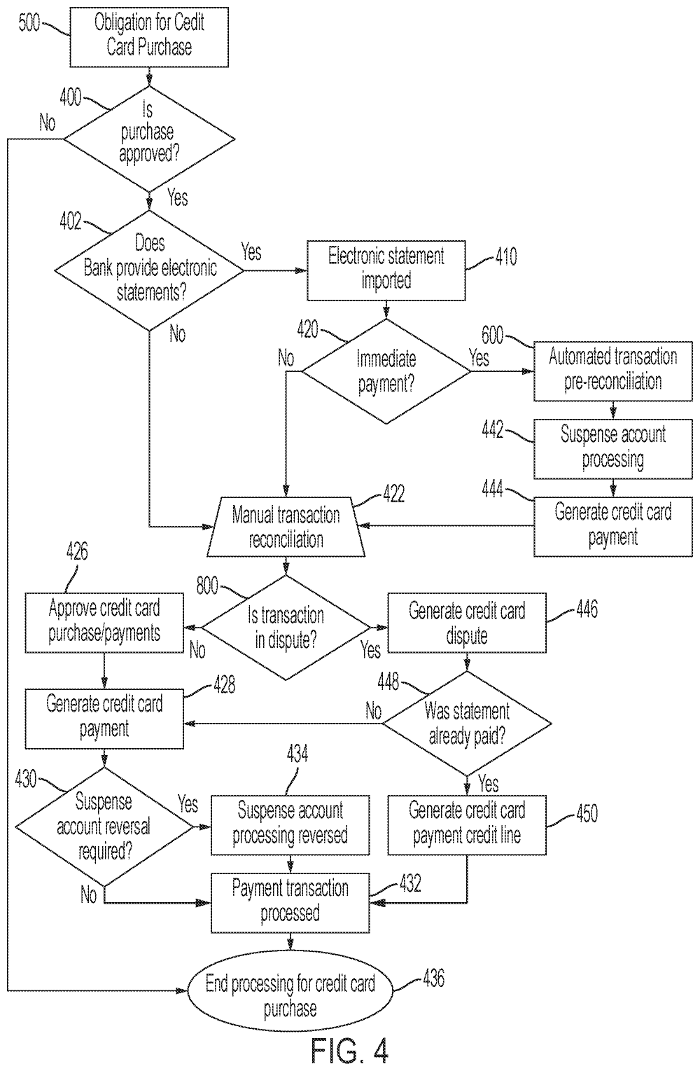

FIG. 4 shows a top level flow of processing credit card transactions, according to an example of the disclosure. A computer 114, comprising: a processor, and a memory to store instructions which when executed by the processor cause the processor to, store, in a plurality of databases 120, including transactional 306, 320; control 304, 308, 310, 312, and reference databases 302, 332, 320, information indicating a plurality of validation information in form of threshold controls to perform electronic payment processes corresponding to electronic charge account purchase transactions, respectively; in response to input of charge account purchase information indicating a forecast of a charge account purchase, generate an electronic obligation transaction 306 resulting from a plurality of verifications of the charge account purchase information based on the plurality of threshold controls in the control databases 304, 308, 310, 312. In response to receipt of a first electronic charge statement 136 including a plurality of statement charge lines, each statement charge line indicating information of a completed charge account purchase, providing a settable payment authorization on a statement charge line by statement charge line basis of the plurality of statement charge lines, resulting from a hybrid payment model setting 330 in the plurality of databases 120 to authorize a payment corresponding to a completed charge account purchase for a statement charge line among the statement charge lines before or after a reconciliation against the obligation transaction.

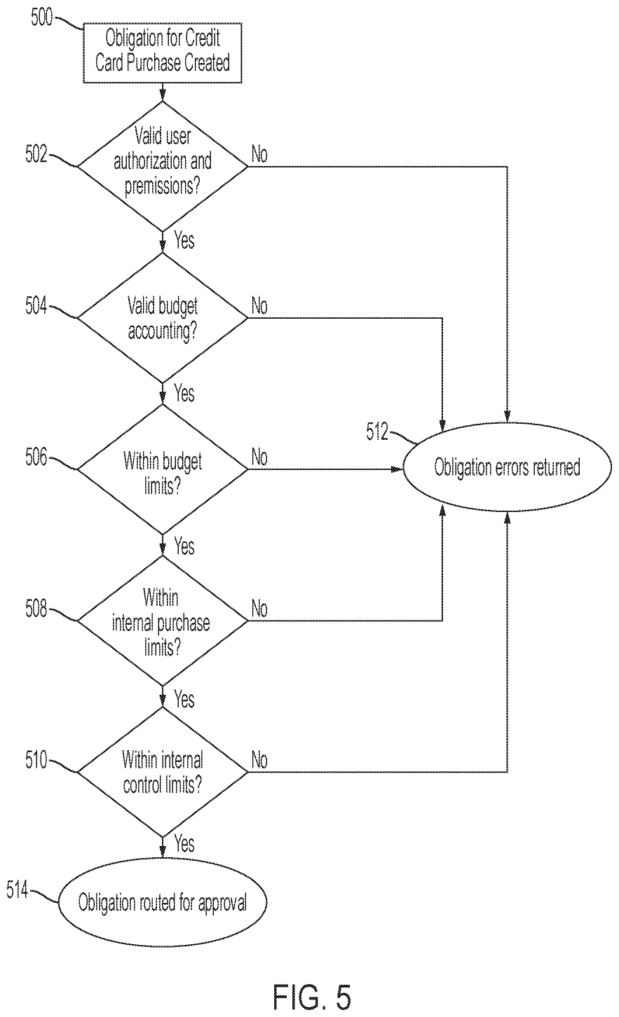

At operation 402, a first user in a first group of users of the financial management system 114 processes an obligation for a credit card purchase. Referring to FIGS. 3A and 3B, at operation 402, the obligation is subjected to a series of validations and controls based on the credit card database 302, the budget database 304, the security and user control database 308, internal credit limits 310, and the single purchase control limits database 312. Operation 402 to create an obligation for a subsequent credit card purchase is described in more detail with reference to FIG. 5. The validations and controls establish a set of rules settable by at least one authorized second user in a second group of users and independent of external validations and controls set in an external credit card system 130 to control the external monetary limit of the credit card.

Referring to FIG. 5, at operation 502, the financial management system electronically validates that the user is authorized to make purchases with the credit card and has permission to record the corresponding obligation in the financial management system, at operation 406, that the budget accounting codes on the transaction are valid for the credit card purchase, at operation 506, that the credit card purchase is within budget limits, at operation 508, that the transaction is within internal purchase limits, and at operation 510, that the credit card purchase is within internal control limits. Internal control limits are broader than just purchasing, as these limits may be dates, user, or other limits. Internal purchase limits may be specific to a purchase transaction, regardless of how the purchase occurred. When the obligation fails any of these validations, at operation 512 errors are returned, and the obligation is not routed to operation 514 for approval. If the obligation is routed to operation 514 for approval, but the obligation is not approved, at operation 550 processing ends .

When the obligation is routed to operation 415 for approval, a second user in a first group of users approves the obligation, and the credit card purchase is recorded as actual spending in the financial management system databases 120. Actual spending information, for example, payment transaction information (e.g., transaction unique identifier and transaction amount), may be stored in the financial transaction database 306.

Referring to FIG. 4, at operation 400, it is determined whether the forecasted purchase is approved. If at operation 400, the forecasted purchase is approved resulting from the obligation process at operation 500, at operation 402, the financial management system 114 may determine whether the external computer system 130, which may include the external credit card issuer process 132 with an external credit card system database 146, and an external payment authority process 138 with an external payment authority database 148, provides an electronic external statement 136. At operation 410, the electronic external statement 136 may be electronically received or imported/retrieved from the external computer system 130. In response to receipt of the electronic credit card statement 136 from the external computer system 130, at operation 410, the processes 110 of the financial management system 114 import the electronic external statement 136 to the reconcilable statement database 332 of the financial management system 114. This operation 410 may map a format of the electronic external statement 136 to a format of records of the reconcilable statement database 332, resulting in a transformation of the external statement 136 into a reconcilable statement 332 associated with a settable statement payment model 330. For example, a statement payment model information 330 which is settable in form of a payment processing rule may be associated with a reconciliation statement 332 in the statement reconciliation database 320.

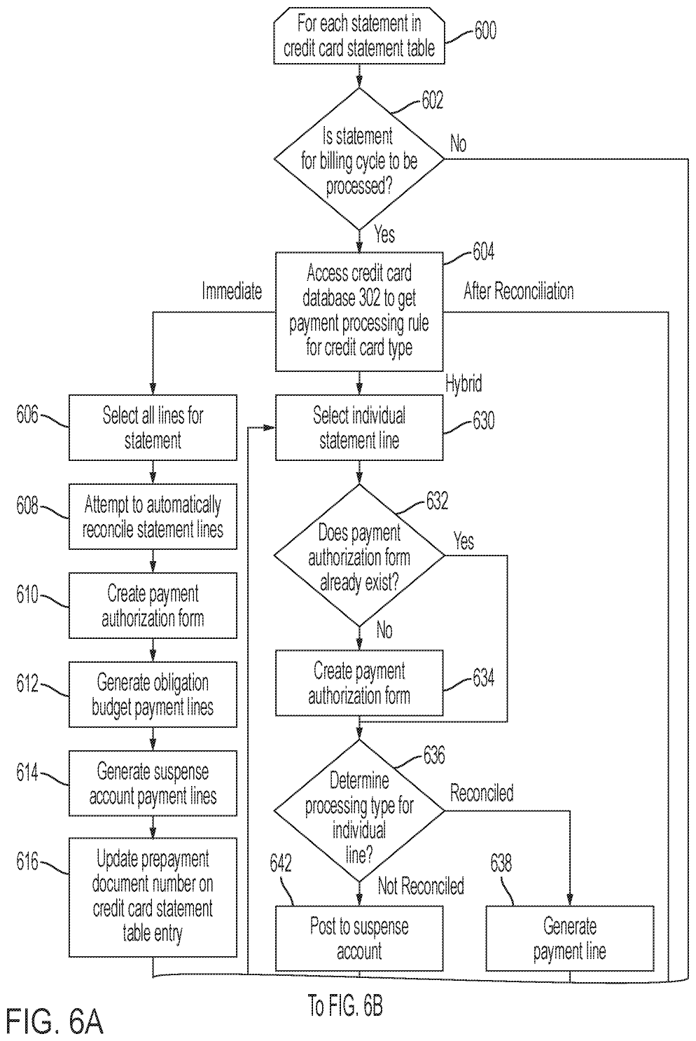

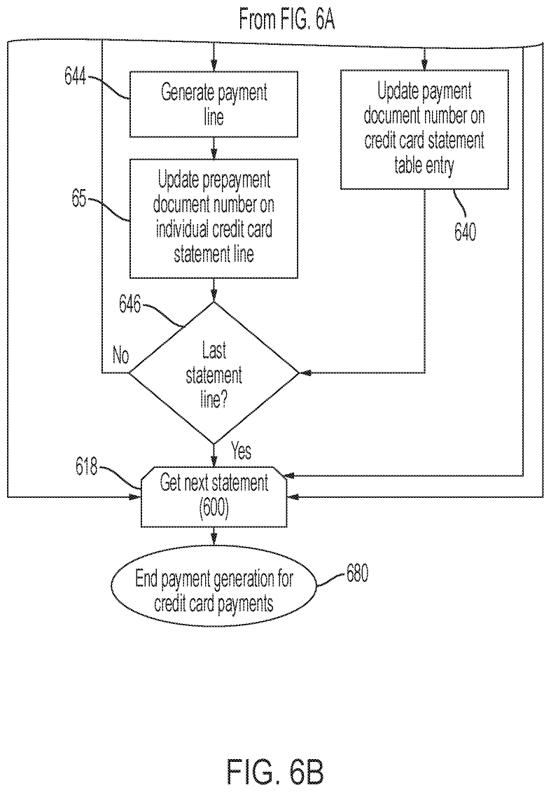

At operation 420, the financial management system 114 may determine how to pay for the charges on the electronic reconciliation statement 332 corresponding to the credit card statement 332, resulting from a statement payment model 330 setting. FIGS. 6, 7, and 8 are flowcharts of payment processing models including a hybrid payment processing of a credit card statement, according to an example of the disclosure. FIGS. 6A and 6B are detail flowcharts of operation 600 to perform a pre-reconciliation process against the databases 120. A pre-reconciliation process is to prompt a user with recommendations to confirm the pre-reconciliation, which may make a subsequent automated reconciliation by the financial management system 114 more efficient. Referring to FIG. 6A, at operation 602, the financial management system 114 selects an unprocessed electronic reconcilable statement 332 from the statement reconciliation database 332 for a current billing cycle. At operation 604, the statement reconciliation database 320 may be accessed to obtain the setting in the statement payment model information 330 to indicate how the electronic reconcilable statement 332 is to be processed.

For example, within the financial management system 114, at least one authorized user of the second group of users may have configured the financial management system databases 120 to electronically impose payment processing rules on how the reconcilable statement 332 may be paid, with the statement payment model type options at operation 604 being determined from the set statement payment model information 330:

1. The statement payment model of ‘Immediate Payment,’ authorizes the reconcilable statement 332 to be automatically paid on a payment due date, regardless of whether the credit card holder has validated to reconcile the accuracy of the credit card transactions on the credit card statement. The statement 332 may be paid by using a suspense account for any credit card statement lines that have not been reconciled. By being able to pay for the transactions on the statement 332 immediately, the organization can seek better credit terms or a prompt payment discount. In this process, if the credit card provider provides discounts for early payment, the “income” associated with the discount can also be calculated, becoming a benefit for organizations with significant credit card purchases. However, tying up a portion of the budget in a suspense account to accommodate the statement payment model type of Immediate Payment can also be a significant burden to an organization with limited funds.

2. The statement payment model of ‘After Reconciliation,’ holds the statement 332 without payment until the credit card holder has validated the accuracy of the credit card transactions on the statement 332. The organization is prevented from having to reserve sufficient funds in a suspense account to cover an unknown amount of credit card purchases during the fiscal period, making these funds unavailable for other use. However, relying on the credit card holder to reconcile in a timely manner can put the organization at risk of incurring penalties and late payment fees.

3. The statement payment model of ‘Hybrid,’ allows the statement 332 to be paid in on the payment due date by paying the statement 332 on a statement line by statement line basis from the obligation budget account instead of the suspense account and paying unreconciled statement lines from the suspense account. For an organization that has the fiduciary authority to pursue this statement payment model, it eliminates both the dual-budgeting of the ‘immediate payment’ model and the late payment risk of the ‘after reconciliation’ model.

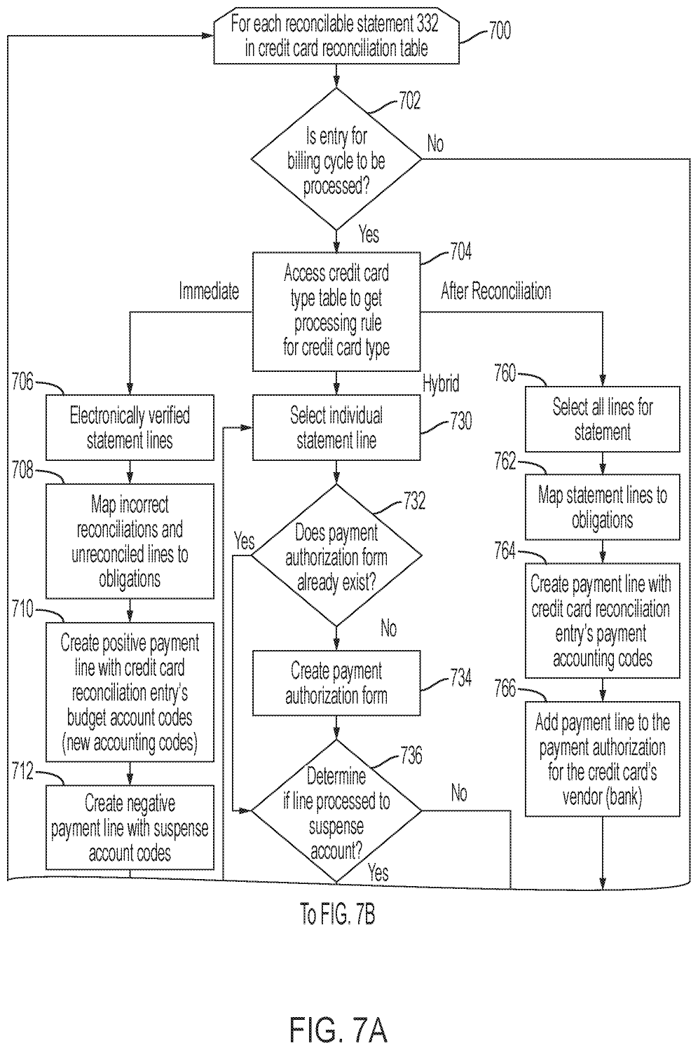

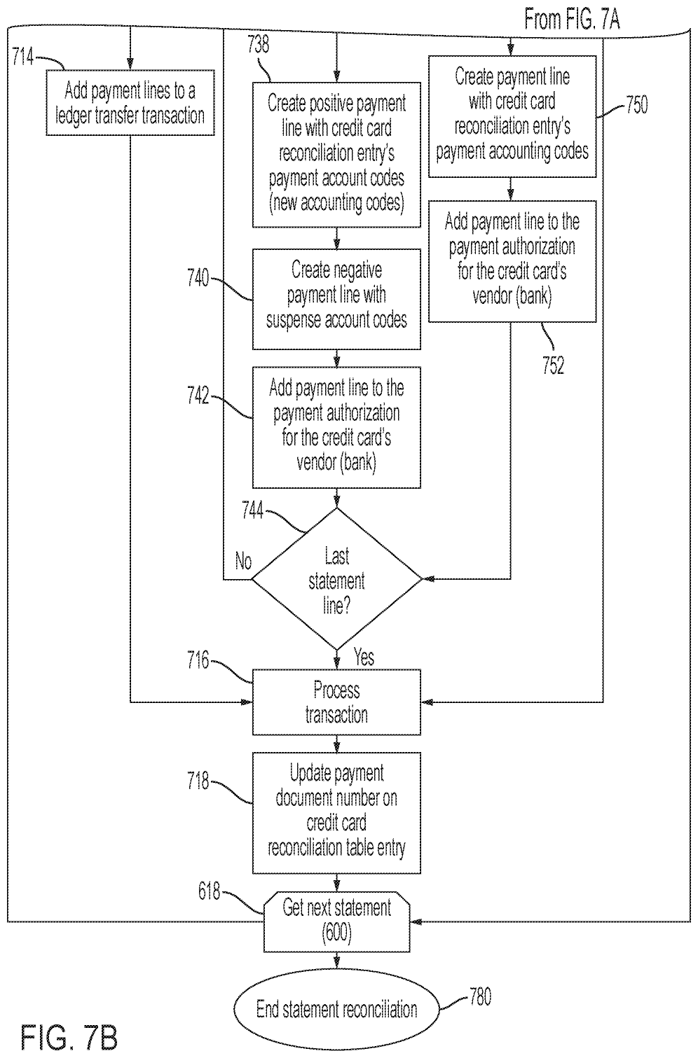

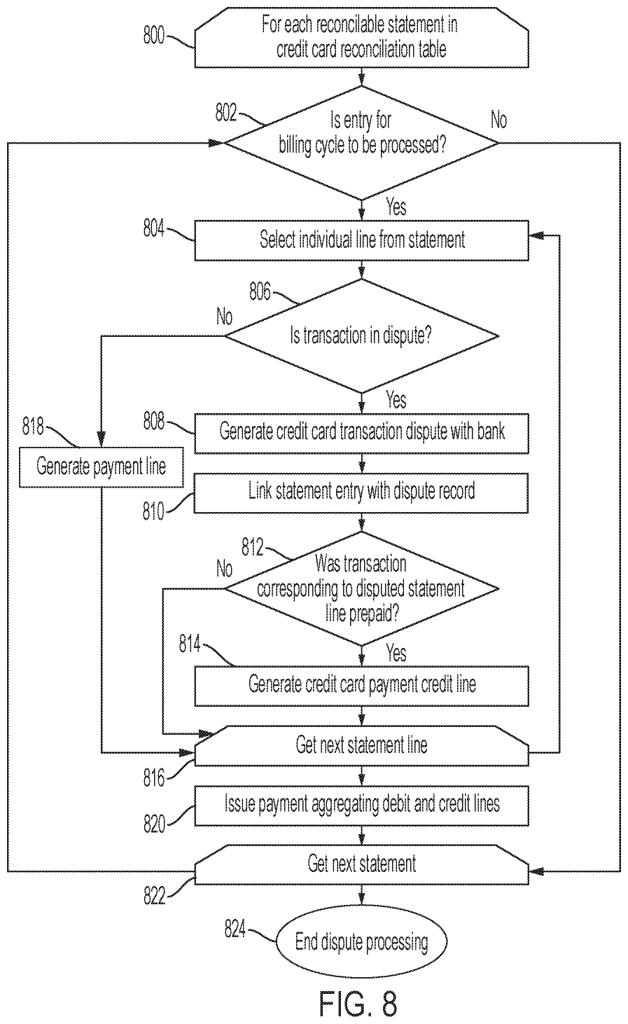

Referring to FIG. 4, if at operation 420, the statement 332 does not require immediate payment, the credit card holder may manually review the credit card statement 332 to validate that all credit card transaction lines represent valid credit card purchases. At operation 800, any invalid purchases are marked for dispute (this will be described later in FIG. 8). At operation 426, the credit card holder may match each credit card statement line to a transaction unique identifier in the financial transaction database 306 to identify the corresponding obligation. At operation 428, once all credit card statement lines are either indicated to be reconciled, or marked for dispute, the financial management system 114 creates a payment authorization transaction to liquidate the obligations and to record the payment amounts to the correct budgetary accounts, using the statement reconciliation database 320 which associates the payment amounts to the credit card database 302, the financial transaction database 306 and the budget database 304. At operation 430, it is determined whether a suspense account reversal is required. When at operation 430, suspense account reversal is required, at operation 434, suspense account processing is reversed, and when at operation 430, suspense account reversal is not required, at operation 432, a payment transaction may be processed. Operations 430 and 434 are described in more detail in FIG. 7.

At operation 432, the payment is processed for the statement balance less any disputed transactions, and the payment transaction number is updated in the statement reconciliation database 320. At operation 436, the processing for the credit card purchase ends to returns to operation 500, and the financial management system 114 then imports/retrieves the next reconcilable statement 332 until all reconcilable statements 332 for the billing cycle are processed.

Referring to FIG. 4, at operation 420, upon a determination that the reconcilable statement 332 may be paid immediately, at operation 600, the financial management system 114 performs automated transaction pre-reconciliation processing. The pre-reconciliation process of operation 540 for processing of a reconcilable statement 332 is described in more detail in FIGS. 6A and 6B.

Referring to FIG. 6A, at operation 602, the financial management system 114 selects an unprocessed electronic reconcilable statement 332 from the statement reconciliation database 320 for a current billing cycle. At operation 604, the statement reconciliation database 320 may be accessed to obtain a setting in the statement payment model information 330 which indicates a statement payment model that may be applied to the reconcilable statement 332. At operation 604, upon the setting in the statement payment model information 330 indicating the electronic reconcilable statement 332 may be processed according to the ‘immediate’ payment processing model, the next operation proceeds to operation 606. At operation 606, the financial management system 114 selects all transaction lines of a reconcilable statement 332, and, at operation 608, attempts to automatically match obligations to credit card statement lines using individual transaction tolerances on amounts and dates and records this preliminary reconciliation and indicates any credit card statement lines that could not be matched. At operation 610, a payment authorization form is generated . At operation 612, payment authorization for the full statement amount with matched lines against the obligation budget account and, at operation 614, payment authorization for unmatched lines are indicated to be charged against the suspense account. At operation 616, the credit card database 302 is updated with the payment authorization number. At a point in the future, at operation 524, the credit card holder reviews the credit card statement to validate that all transaction lines represent valid purchases. Any invalid purchases are marked for dispute, and the financial management system generates a request for credit to the credit card provider (this will be described later).

Referring to FIGS. 6A and 6B, at operation 604, upon the setting in the statement payment model information 330 indicating the electronic reconcilable statement 332 may be processed according to the ‘hybrid’ payment processing model, the next operation proceeds to operation 630. At operation 630, a first statement line of the reconcilable statement 332 is selected. When, at operation, 632, a payment authorization exists, and, at operation 636, the credit card holder has reconciled the statement line, at operation 638, the financial management system 114 adds a payment line to correspond to the statement line of the reconcilable statement 332 in the statement reconciliation database 320 using the budget accounting codes from the financial transaction database 306 in form of budget unique identifier and reconciliation budget unique identifier . At operation 640, the payment document number is updated in the credit card database 302. When, at operation 636, the credit card holder has not reconciled the statement line, at operation 642, a payment may be posted to a suspense account, at operation 644, a payment line to correspond to the statement line of the reconcilable statement 332 in the statement reconciliation database 320 is added using the suspense accounting codes resulting from operation 642, and, at operation 646, the payment line is added to the prepayment document number in the databases 120. By way of operation 646, the financial management system 114 cycles through all statement lines on the reconcilable statement 332 until the last statement line is processed. At that point, the financial management system 114, at operation 618, retrieves the next reconcilable statement 332 until, at operation 680, all statements for the billing cycle are processed.

For statements and statement lines of the reconcilable statement 332 that have been paid from a suspense account, resulting from operations 614 and 642, respectively, the credit card holder may reconcile the reconcilable statement 332 after payment has been made as described in FIGS. 7A and 7B.

Referring to FIGS. 7A and 7B, operation 700 represents operations performed for each reconcilable statement 332 in the statement reconciliation database 320 after the pre-reconciliation process of FIGS. 6A and 6B. At operation 702, it is determined whether a reconcilable statement 320 for a billing cycle is to be reconciled. At operation 704, the credit card database 302 is accessed to obtain the statement payment processing model 330 information. When the statement payment processing model 330 indicates ‘Immediate’ payment model, at operation 706, the pre-reconciliation of the statement lines of the reconcilable statement 332 may be manually or electronically verified. For example, at operation 708, the credit card holder or the processes 110 of the financial management system 114 reconcile the preliminary reconciliation of operation 600 to confirm that the preliminary reconciliation the statement lines were matched correctly to the corresponding obligation in the financial transaction database 306 or to change the match. At operation 708, unmatched credit card statement lines may be processed to identify the corresponding obligation in the financial transaction database 306. Once, at operation 708, all credit card statement lines are reconciled, at operation 710, the financial management system 114 processes a suspense account reversal to liquidate the correct obligations, and, at operation 712, to move the payment amounts to the correct budgetary accounts. At operation 714, the payments and reversals are processed on a ledger transfer transaction internal to the financial management system to move the funds within the budget to the correct accounting codes. At operation 716, a payment transaction is processed. At operation 718, the statement lines of the reconcilable statement 332 in the statement reconciliation database 320 are updated with the new payment transaction codes. After operation 616, the process returns to operation 618, so that the financial management system 114, at operation 600, retrieves the next reconcilable statement 332 until all reconcilable statements 332 for a billing cycle are processed at operation 670 and, at operations 680 and 780, payment generation and reconciliation of the reconcilable statements 332 end, respectively.

Referring to FIGS. 7A and 7B, when, at operation 704, the statement payment processing model 330 indicates ‘Hybrid’ payment model, at operation 730, a statement line among the statement lines of the reconcilable statement 332 is selected. At operation 732, it is determined whether a payment authorization form exists. When, at operation 732, it is determined that a payment authorization form does not exist, at operation 734, a payment authorization form, for example, in form of transaction number/identifier to be corresponded to a payment transaction number, and transaction amount information to be corresponded to a payment amount, corresponding to the statement line is generated and may be stored in the financial transaction database 306 and correspondingly referenced in the statement reconciliation database 320. At operation 736, it is determined if a payment corresponding to the statement line has been processed from a suspense account. If at operation 736, it is determined that a payment has been processed from a suspense account, at operation 738, a positive payment line with credit card reconciliation entry's payment account codes (new accounting codes) is created. At operation 740, a negative payment line with suspense account code is created. At operation 742, a payment line is added to the payment authorization for the credit card's vendor (for example, a bank). By way of operation 744, all statement lines of the reconcilable statement 332 are processed for payment.

When, at operation 736, it is determined that the statement line has not been processed from a suspense account, at operation 750, a payment line with credit card reconciliation entry's payment accounting codes is created. At operation 752, a payment line may be added to the payment authorization for the credit card's vendor (for example, a bank)

Referring to FIGS. 7A and 7B, when, at operation 704, the statement payment processing model 330 indicates ‘After Reconciliation’ payment model, at operation 760, all statement lines of the reconcilable statement 332 are selected. At operation 762, the statement lines are mapped to the obligations in the financial transaction database 306. At operation 764, a payment line with credit card reconciliation entry's payment accounting codes is created. At operation 766, a payment line may be added to the payment authorization for the credit card's vendor (for example, a bank)

Referring to FIG. 4, after the automated transaction pre-reconciliation of operation 500 is completed, at operation 442, suspense account processing is performed, which is described in more detail in FIGS. 6A-6B and 7A-7B. At operation 444, credit card payment is generated. After payment information for a reconcilable statement 332 is generated in operation 444, or in case electronic external statements 136 are not available, at operation 422, an additional manual credit card transaction reconciliation may be performed by way of a computer user interface. For example, at operation 800, during the manual reconciliation performed by the credit card holder, the individual statement lines may displayed via screen displays on the computing devices 101, allowing the credit card holder to confirm whether the purchase is correct and should be paid, resulting in information indicating a credit card transaction is in dispute. In this process, for example, the credit card holder may review the credit card statement lines against purchase receipts and other personal notes and indicates whether the purchase is correct or not. The purchase can be in dispute for a number of different reasons, such as the purchase amount on the statement being incorrect due to returns of part of the purchase, the purchaser not being satisfied with the purchased items or service, or the items or service purchased not being received.

Operation 800 is described in more detail in FIG. 8. Referring to FIG. 8, at operation 802, when a reconcilable statement 332 for a billing cycle may be processed, at operation 804, a statement line of the reconcilable statement 332 may be selected. At operation 803, the credit card holder may mark a credit card transaction corresponding to the selected statement line as disputed by way of the user interface resulting in generation of dispute information in form of a dispute record stored in the databases 120. When at operation 806, a credit card transaction is indicated to not be in dispute, at operation 818, a payment line corresponding to the reconcilable statement is generated. At operation 818, the financial management system 114 retrieves the reconciled statement 332 information from the statement reconciliation database 320 at the time that a payment is being generated. If the statement line is not in dispute, the financial management system proceeds with generating a payment line for the transaction corresponding to the non-disputed statement line.

When, at operation 806, a credit card transaction is indicated to be in dispute, at operation 808, the financial management system 114 generates a dispute notification, which identifies the card number, the transaction, the amount, the type of dispute, and the credit card holder's justification for the dispute, and sends the dispute information to the external credit card system 130. At operation 810, the financial management system 114 may send the dispute notification to the external credit card system 130 electronically and updates the statement line with a dispute notification identifier, resulting in a link between the statement line and the dispute information.

At operation 812, it may be indicated whether the disputed statement line is prepaid. When at operation 812, the disputed statement line is prepaid, at operation 814, a credit card payment credit line is generated. When, at operation 812, the disputed statement line has not already been paid, at operation 816, the next statement line is processed, resulting in a holding of the current statement line as unpaid until the dispute is resolved. When, at operation 812, a disputed statement line has already been paid, at operation 814, the paid disputed statement lines are added to the payment transaction as a credit line. For example, at operation 814, the disputed statement lines of the reconcilable statement 332 are updated with the document number of the credit transaction.

At operation 820, payment information is generated which may be based on aggregating debit and credit lines. At operation 820, after the dispute processing of the statement lines of a reconcilable statement 332 are completed, at operation 822, the next reconcilable statement 332 is obtained for dispute processing. At operation 824, the dispute processing may end after dispute processing of all the reconcilable statements 332 is completed.

Referring to FIG. 4, when, at operation 800, it is determined that a credit card transaction is in disputed, at operation 446, a credit card dispute is generated. At operation 448, it is determined whether the reconcilable statement 332 has been paid. If, at operation 448, it is indicated that the reconcilable statement 332 has been paid, at operation 450, a credit card payment credit line is generated which indicates a credit to be applied to a credit card purchase transaction. At operation 432, a payment transaction is processed. When, at operation 448, it is indicated that the reconcilable statement 332 has not been paid, at operation 428, a credit card payment is generated. Operation 428 occurs when a reconcilable statement 332 is to be paid for undisputed statement lines. Operation 450 occurs when there is disputed a charge that was already paid, so financial management system 114 processes a credit card purchase transaction with a credit line indicator indicating a credit to be applied.

The processes 110 of the financial management system rely on an event driven loop model, in which each cycle of a loop in FIGS. 4-7 corresponds to an event that has been created or a database record that has been updated in the databases 120. When all events have been processed or database records have been updated, processing may end.

When the electronic statement is received from the credit card provider and imported to the credit card database, the financial management system loops through each line in the electronic statement and attempts to insert it into the statement table of the credit card database. Successful lines are inserted, and failed lines return one or more errors, such as an incorrect format or an invalid credit card number. When all lines from the electronic statement have been inserted or failed, the loop ends.

At the beginning of each billing cycle, the financial management system loops through the statements for the current billing cycle or any prior billing cycles. Statements are electronically reviewed one at a time to select those that are fully or partially unpaid as eligible for the current billing cycle. When all eligible statements have been identified, the loop ends.

When the statement lines are selected the eligible statements, the financial management system loops through the individual lines to determine if a dispute has been filed, if the line has been reconciled, and if the line has already been paid. A credit or debit line is created on the payment transaction for each statement line that will be paid during this billing cycle. When all lines for the billing cycle have been added to the payment transaction, the loop ends, and the payment transaction is processed.

If no records are found during any of these loops, the financial management system returns a notification that the processor could not find eligible data.

Therefore, according to an example of the disclosure, a non-transitory computer readable medium stores a program that, when executed by at least one computer in a computer system that is integrated with an external credit card provider system 130 for receipt of electronic external statement data 136 and, cause the at least one computer to execute at least one process to electronically verify enforcement of rules to process electronic credit card purchase transactions input to the computer system, the at least one process including storing, using financial management system control databases, information indicating a plurality of validation information to process the electronic credit card purchase transactions associated with information identifying credit cards usable to initiate the electronic credit card purchase transactions, the financial management system databases including, a budget database 304 including budget plans defined by authorized budget account codes and specifying available money to be spent, suspense plans defined by authorized suspense account codes for use when budget alignment cannot be determined at the time of credit card transaction processing, and spending actuals resulting from credit card transaction processing against a specific budget plan, a suspense account, or resulting from transfer from a suspense account to a specific budget plan after transaction reconciliation; a credit card purchase transaction database 302 including reference data on the credit card types and valid credit cards and where the external credit card provider's electronic statements 136 may be stored when ingested to the financial management system 114 for processing; a single purchase limit database 312 including internal credit card rules specifying a set of purchase limits, account limits, and budget limits, the credit card rules settable by at least one authorized first user in a first group of users in the security and user controls database 308; an internal credit limit database 310 including a set of internal credit limits on a credit card among the credit cards and a second user basis, including a transaction credit limit, amount and date tolerances associated with the transaction credit limit, and a billing cycle limit. The set of internal credit limits settable by the at least one first user in the first group of users prior to occurrence of an electronic credit card purchase transaction, independent of an external monetary limit set by an external card system 130 to control the external monetary limit of the credit card.

A security and user control database 308 including security and approval control information and information identifying the second user in a second group of users other than the first group of users to authorize the second user to request electronic obligation processing of an individual electronic credit card purchase transaction for an individual credit card and to apply an approval to the individual electronic credit card purchase transaction and identifying a second user in the second group of users to authorize how payment of the actual credit card transaction information from the external credit card provider occurs.

The at least one computer is to perform creating a financial transaction database 306 to link information indicating an electronic approval of the electronic obligation processing request by the second user for the individual credit card purchase transaction to the internal credit card rules in the single purchase limit database, and the set of internal credit limits in the internal financial system credit limit database, in response to the system electronically receiving through a first user device among the user devices an obligation processing request including, an alias configured for the individual credit card and an anticipated electronic credit card purchase transaction, an anticipated credit card purchase amount and an anticipated credit card purchase transaction purpose, prior to the occurrence of the individual electronic credit card purchase transaction, the authorized account codes designating transaction processing directly against an authorized budget account or against a suspense account.

The electronic approval of the obligation processing request may be subjected to a plurality of controls in the financial management system control databases 304, 308, 310 and 312 of the databases 120 in order of, a first electronic verification to verify security authorization of the second user according to the security control information in the security control database, and a plurality of second verifications of the internal credit card rules and the internal credit limits to, electronically first verify the anticipated credit card purchase transaction purpose corresponds to the authorized account codes for the second user and the individual credit card in the internal credit limits and is within a purchase limit, an account limit, and an account code limit of an internal credit card rule for the individual credit card in the single purchase limit database, electronically second verify the anticipated credit card purchase amount is within the billing cycle limit for second user and the individual credit card is within the internal credit limits, electronically third verify the anticipated credit card purchase amount is within the amount and date tolerances in the internal credit limits, and electronically fourth verify the anticipated credit card purchase amount is within the budget limit of the internal credit card rule of at least one authorized first user in the single purchase limit database and corresponding to the authorized account codes.

In response to the electronic approval of the obligation processing according to the ordered first and plurality of second electronic verifications, link the electronic approval of the obligation processing request to the internal credit card rules and the internal credit limits in the single purchase limit and the internal financial system credit limit databases by electronically allocating an obligation identifier and inserting the obligation identifier and the configured alias to be associated with the approved obligation processing request of the second user for the individual credit card; and in response to electronic receipt of actual credit card purchase transaction information from the external credit card provider for payment, storing, in a credit card purchase transaction database, information indicating an actual credit card purchase amount, an actual credit card purchase transaction purpose, and ledger account information associated with the actual individual credit card purchase transactions, from the external card system, and allowing designation of whether the actual credit card purchase transaction information is to be processed wholly to a suspense account code to allow immediate payment, require reconciliation of the actual purchase transactions to an authorized budget account code prior to payment processing, or allow a hybrid designation 330 at the ledger level of actual purchase transaction processing.

When designated for immediate payment against the suspense account code, the at least one computer is to perform identifying the approved obligation processing request corresponding to the credit card purchase transaction information in the credit card transaction database according to the obligation identifier and the configured alias in the financial transaction database to, perform an electronic third verification by, electronically verifying the actual credit card purchase amount matches the anticipated credit card purchase amount within the associated amount and date tolerances in the internal credit limits database, electronically verifying the actual credit card purchase transaction purpose matches the anticipated obligation transaction purpose, electronically verifying security information of the user matches the security authorization of the second user in the security controls database, and electronically track the obligation processing request in the computer system across the single purchase limit, internal credit limits, security control and financial transaction databases, to output information indicative of a reconciliation of the actual credit card purchase transaction with the obligation transaction to indicate, through the reconciliation, a validation of the actual credit card purchase transaction with the single purchase limit and internal credit limits; cause electronic enforcement of the single purchase limit and the internal credit limits in the internal financial system credit limit database for the actual credit card purchase transaction by the computer system independent of the external card system; and retrieve the authorized suspense account codes from the obligation transaction to allow transfer of the spending actuals from the authorized suspense account codes to the authorized budget account codes to return the spending actuals at the transaction level and aggregated for the financial system. OR when designated to require reconciliation prior to payment, mapping the approved obligation processing requests corresponding to the credit card purchase transaction information in the credit card transaction database according to the obligation identifier and the configured alias in the financial transaction database, and retrieving any previously processed payment transactions against the authorized suspense account codes from the spending actuals database to allow transfer of the spending actuals from the authorized suspense account codes to the authorized budget account codes to, designate the authorized budget account codes to be used for payment processing, and perform an electronic third verification by, electronically verifying the actual credit card purchase amount matches the anticipated credit card purchase amount within the associated amount and date tolerances in the internal credit limits database, electronically verifying the actual credit card purchase transaction purpose matches the anticipated obligation transaction purpose, electronically verifying security information of the user matches the security authorization of the second user in the security controls database, and electronically tracking the obligation processing request in the computer system across the single purchase limit, internal credit limits, security control and financial transaction databases, to output information indicative of a reconciliation of the actual credit card purchase transaction with the obligation transaction to indicate, through the reconciliation, a validation of the actual credit card purchase transaction with the single purchase limit and internal credit limits; cause electronic enforcement of the single purchase limit and the internal credit limits in the internal financial system credit limit database for the actual credit card purchase transaction by the computer system independent of the external card system, and process the actual credit card transaction to the authorized budget account codes to return the spending actuals at the transaction level and aggregated for the financial system. OR when where hybrid ledger level designation occurs, separating the individual actual ledger level transactions based on identification by an authorized user of the first group to allow immediate payment or require reconciliation prior to payment processing, after which each subset of actual ledger level transactions is processed according to the defined rules of its designation.

The computer system 100 performs financial management operations including budget management, purchasing, accounts payable, accounts receivable, and other functions. A suitable operating system for the architecture depicted in FIG. 1 may be the LINUX operating system or the MICROSOFT WINDOWS operating system. A suitable set of programming languages include using C++ and/or Java for business logic processor components and Angular and/or Java for the user interface components. A suitable platform for hosting the financial management system data may be a relational database management system, a NoSQL database, an object oriented database, or similar platform that could host the required schemas. The work-stations and devices suitable for accessing the financial management system are typically agnostic to the technologies used within the financial management system. The computers of the financial management system architecture include the computer readable storage (RAM, ROM disks, etc.) upon which the processes and data structures of the present invention can be stored and distributed to customers, if desired. The processes can also be distributed to purchasers via downloading over a network, such as a packet switched network using an electromagnetic wave, such as a carrier wave.

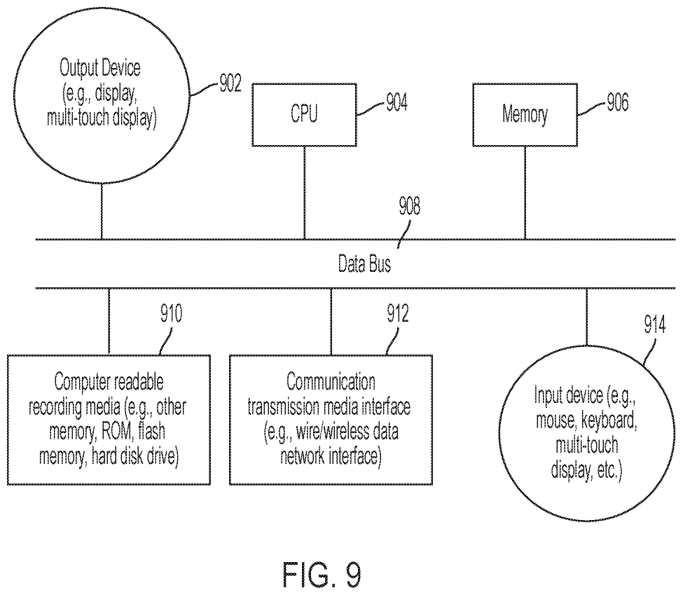

According to an aspect of an embodiment, the described features, functions, operations, and/or benefits can be implemented by and/or use processing hardware and/or software executed by processing hardware. For example, a computing apparatus as illustrated in FIG. 9 can comprise a central processing unit (CPU) or computing processing system 904 (e.g., one or more processing devices (e.g., chipset(s), including memory, etc.) that processes or executes instructions, namely software/program, stored in the memory 906 and/or non-transitory computer readable media 912, transmission communication interface (network interface) 910, input device 914, and/or an output device 902, for example, a display device, a printing device, and which are coupled (directly or indirectly) to each other, for example, can be in communication among each other through one or more data communication buses 908.

In addition, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.) collectively referred to as hardware processor(s), to achieve the functions or operations being described. The functions of embodiments described can be implemented in any type of apparatus that can execute instructions or code.

More particularly, programming or configuring or causing an apparatus or device, for example, a computer, to execute the described functions of embodiments of the invention creates a new machine where in case of a computer a general purpose computer in effect becomes a special purpose computer once it is programmed or configured or caused to perform particular functions of the embodiments of the invention pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, solid state drive (SSD), etc.).

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

The many features and advantages of the invention are apparent from the detailed specification, and thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A computer, comprising:
a processor, and
a memory to store instructions which when executed by the processor cause the processor to,
store, in a plurality of internal databases, internal information controlled by the computer, the internal information indicating a plurality of validation information in form of threshold controls settable by a first group of first users to perform electronic payment processes corresponding to completed electronic charge account purchases, respectively, by a second group of second users of the computer, the second users respectively associated with charge accounts, the charge accounts controlled by an external computer storing external information for the charge accounts;
the plurality of internal databases including,
a financial transaction database to store electronic obligation and payment transactions;
a single purchase limit database including internal charge account rules specifying a set of purchase limits, account limits, and budget limits, the internal charge account rules settable as a threshold control by at least one authorized first user in the first group of first users of the computer;
an internal financial system charge account limit database including a set of internal credit limits on a charge account, among the charge accounts, and a second user in the second group of second users of the computer basis,
the set of internal credit limits including a transaction credit limit, amount and date tolerances associated with the transaction credit limit, a billing cycle limit, and authorized budget account codes, and
the set of internal credit limits settable by at least one authorized first user as a threshold control prior to occurrence of an electronic charge account purchase transaction, and independent of external monetary limits set by the external computer in the external information for the charge accounts to control an external monetary limit of the charge account associated with the second user; and
a security control database including security control information and information identifying the second user to authorize the second user to request an electronic obligation transaction corresponding to the electronic charge account purchase, and to apply an approval to the electronic charge account purchase based on an electronic verification of the electronic obligation transaction,
in response to input of electronic charge account purchase information indicating a forecast of an electronic charge account purchase, generate a verified electronic obligation transaction resulting from a plurality of automatic electronic verifications of the electronic charge account purchase information based on the plurality of threshold controls by,
electronically verifying the electronic obligation transaction subject to the plurality of threshold controls in order of,
a first electronic verification to verify security authorization of the second user according to the security control information in the security control database, and
a plurality of second electronic verifications of the internal charge account rules and the set of internal credit limits to,
electronically first verify a purpose of the charge account purchase corresponds to the authorized budget account codes for the second user and the charge account in the internal charge account limits and is within a purchase limit, an account limit and a budget limit of an internal charge account rule for the charge account in the single purchase limit database,
electronically second verify a charge account purchase amount is within a billing cycle limit for second user and the charge account in the internal charge account limits,
electronically third verify the charge account purchase amount is within the charge account purchase amount and the date tolerances, in the internal charge account limits, and
electronically fourth verify the charge account purchase amount is within the budget limit of the internal charge account rule of at least one authorized first user in the single purchase limit database, and
in response to the electronic verification of the electronic obligation transaction according to the ordered first and plurality of second electronic verifications,
linking information indicating the electronic verification of the electronic obligation transaction by the second user for the charge account purchase information, to the internal charge account rules and the set of internal account limits, in the single purchase limit and the internal financial system charge account databases, respectively, by electronically allocating an obligation identifier and inserting the obligation identifier to be associated with the requested electronic obligation transaction of the second user for the charge account purchase information, to generated the verified electronic obligation transaction; and
in response to receipt of a first electronic charge statement including a plurality of statement charge lines from the external computer storing the external information for the charge accounts, providing a settable payment authorization on a statement charge line by statement charge line basis of the plurality of statement charge lines,
the statement charge line indicating information of a completed electronic charge account purchase among completed electronic charge account purchases,
the settable payment authorization resulting from a hybrid payment model setting enabled in the plurality of internal databases according to the verified electronic obligation transaction and based upon a transformation of the first electronic charge statement into a second electronic charge statement including the setting of the hybrid payment model to indicate authorization of a payment corresponding to the completed electronic charge account purchase for a statement charge line among the statement charge lines before or after a reconciliation against the verified electronic obligation transaction,
wherein to further indicate the authorization of the payment, the processor is to associate information indicating a payment transaction to the statement charge line.

2. (canceled)

3. The computer according to claim 1, wherein the verified electronic obligation transaction is associated with a budget account for payment without reconciliation, and the payment is from a suspense account or a budget account according to the plurality of databases.

4. (canceled)

5. The computer according to claim 1, wherein the verified electronic obligation transaction further indicates both an obligation and the corresponding payment transaction for the statement charge line.

6. The computer according to claim 5, wherein the processor is to,
in response to receipt of the first electronic charge statement from the external computer, identify the verified obligation transaction corresponding to the received first electronic charge statement according to the obligation identifier to,
perform an electronic third verification by,
electronically verifying an actual credit card purchase amount is within the forecasted credit card purchase amount including the associated amount and date tolerances in the set of internal credit limits,
electronically verifying the actual credit card purchase transaction purpose matches the forecasted purpose of the obligation transaction,
electronically verifying security information of the user matches the security authorization of the second user in the security control database, and
electronically verifying security information of the user matches the security authorization of the second user in the security control database, and
electronically track the obligation and payment transactions in the computer within the financial transaction database, to output information indicative of a reconciliation of the completed electronic charge account purchase with the obligation transaction to indicate, by way of the reconciliation, a validation of the completed electronic charge account purchase with the single purchase limit and the set of internal credit limits, and to cause electronic enforcement of the single purchase limit and the set of internal credit limits in the internal financial system credit limit database for the completed charge account purchase by the computer independent of the external computer.

7. A non-transitory computer readable medium storing a program that, when executed by at least one computer in a computer system that is integrated with an external credit card provider system for receipt of electronic data and, cause the at least one computer to execute at least one process to automatically electronically verify enforcement of rules to process electronic credit card purchase transactions input to the computer system, the at least one process comprising:
storing, in a plurality of internal financial management system control databases, internal information controlled by the at least one computer, the internal information indicating a plurality of validation information in form of threshold controls settable by a first group of first users to process the electronic credit card purchase transactions associated with information identifying credit cards usable to initiate the electronic credit card purchase transactions, by a second group of second users of the at least one computer, the second users respectively associated with credit card accounts, the credit card accounts controlled by the external credit card provider system storing external information for the credit card accounts, the plurality of internal financial management system control databases including,
a budget database including budget plans defined by authorized budget account codes and specifying available money to be spent, suspense plans defined by authorized suspense account codes for use when budget alignment is not determinable at a time of credit card transaction processing, and spending actuals resulting from credit card transaction processing against a specific budget plan, a suspense account, or resulting from transfer from a suspense account to a specific budget plan after transaction reconciliation;
a credit card purchase transaction database including reference data on credit card types and valid credit cards, and electronic statements ingested from the external credit card provider system to the financial management system for processing;
a single purchase limit database including internal credit card rules specifying a set of purchase limits, account limits, and budget limits, the credit card rules settable as a threshold control by at least one authorized first user in the first group of first users;
an internal credit limit database including a set of internal credit limits on a credit card among the credit cards and a second user in the second group of second users basis, including a transaction credit limit, amount and date tolerances associated with the transaction credit limit, and a billing cycle limit;
the set of internal credit limits settable as a threshold control by at least one first user in the first group of first users prior to occurrence of an electronic credit card purchase transaction, independent of external monetary limits set by the external card provider system to control an external monetary limit of the credit card for the second user;
a security control database including security control information and information identifying the second user to authorize the second user to request an electronic obligation transaction of an individual electronic credit card purchase transaction for an individual credit card and to apply an approval to the individual electronic credit card purchase transaction based on an electronic verification of the electronic obligation transaction;
creating a financial transaction database to link information indicating an electronic verification of the electronic obligation transaction by the second user for the individual credit card purchase transaction, to the internal credit card rules in the single purchase limit database, and to the set of internal credit limits in the internal financial system credit limit database, in response to the system electronically receiving through a user device of the second user a request for an electronic obligation transaction including,
an alias configured for the individual credit card and an anticipated electronic credit card purchase transaction, an anticipated credit card purchase amount and an anticipated credit card purchase transaction purpose, prior to the occurrence of the individual electronic credit card purchase transaction,
the authorized account codes designating transaction processing directly against an authorized budget account or against a suspense account;
the electronic verification of the electronic obligation transaction subjected to the plurality of threshold controls in the financial management system control databases in order of,
a first electronic verification to verify security authorization of the second user according to the security control information in the security control database, and
a plurality of second electronic verifications of the internal credit card rules and the set of internal credit limits to,
electronically first verify the anticipated credit card purchase transaction purpose corresponds to the authorized account codes for the second user and the individual credit card in the set of internal credit limits and is within a purchase limit, an account limit, and an account code limit of an internal credit card rule for the individual credit card in the single purchase limit database,
electronically second verify the anticipated credit card purchase amount is within the billing cycle limit for second user and the individual credit card is within the set of internal credit limits,
electronically third verify the anticipated credit card purchase amount is within the amount and date tolerances in the set of internal credit limits, and
electronically fourth verify the anticipated credit card purchase amount is within the budget limit of the internal credit card rule of at least one authorized first user in the single purchase limit database and corresponding to the authorized account codes, and
in response to the electronic verification of the electronic obligation transaction according to the ordered first and plurality of second electronic verifications,
link the electronic verification of the electronic obligation transaction to the internal credit card rules and the set of internal credit limits in the single purchase limit and the internal financial system credit limit databases by electronically allocating an obligation identifier and inserting the obligation identifier and the configured alias to be associated with the verified obligation transaction of the second user for the individual credit card; and
in response to electronic receipt of actual credit card purchase transaction information from the external credit card provider system for payment,
storing, in the credit card purchase transaction database, information indicating an actual credit card purchase amount, an actual credit card purchase transaction purpose, and ledger account information associated with the actual individual credit card purchase transactions, from the external credit card provider system, and
allowing designation of whether the actual credit card purchase transaction information is to,
be processed wholly to a suspense account code to allow immediate payment,
require reconciliation of the actual purchase transactions to an authorized budget account code prior to payment processing, or
allow a hybrid designation at the ledger level of actual purchase transaction processing; and
where designated for immediate payment against the suspense account code, identifying the verified obligation transaction corresponding to the credit card purchase transaction information in the credit card transaction database according to the obligation identifier and the configured alias in the financial transaction database to,
perform an electronic third verification by,
electronically verifying the actual credit card purchase amount matches the anticipated credit card purchase amount within the associated amount and date tolerances in the set of internal credit limits,
electronically verifying the actual credit card purchase transaction purpose matches the anticipated obligation transaction purpose,
electronically verifying security information of the user matches the security authorization of the second user in the security control database, and
electronically track the verified obligation transaction in the computer system across the single purchase limit, the internal credit limit, the security control, and the financial transaction databases, to
output information indicative of a reconciliation of the actual credit card purchase transaction with the obligation transaction to indicate, through the reconciliation, a validation of the actual credit card purchase transaction with the single purchase limit and the set of internal credit limits;
cause electronic enforcement of the single purchase limit and the set of internal credit limits for the actual credit card purchase transaction by the computer system independent of the external credit card provider system; and
retrieve the authorized suspense account codes from the obligation transaction to allow transfer of the spending actuals from the authorized suspense account codes to the authorized budget account codes to return the spending actuals at the transaction level and aggregated for the financial system; or
where designated to require reconciliation prior to payment, mapping the verified obligation transaction corresponding to the credit card purchase transaction information in the credit card transaction database according to the obligation identifier and the configured alias in the financial transaction database, and
retrieving any previously processed payment transactions against the authorized suspense account codes from the spending actuals database to allow transfer of the spending actuals from the authorized suspense account codes to the authorized budget account codes to,
designate the authorized budget account codes to be used for payment processing, and
perform an electronic third verification by,
electronically verifying the actual credit card purchase amount matches the anticipated credit card purchase amount within the associated amount and date tolerances in the set of internal credit limits,
electronically verifying the actual credit card purchase transaction purpose matches the anticipated obligation transaction purpose,
electronically verifying security information of the user matches the security authorization of the second user in the security control database, and
electronically tracking the verified obligation transaction in the computer system across the single purchase limit, the internal credit limit, the security control, and the financial transaction databases, to
output information indicative of a reconciliation of the actual credit card purchase transaction with the obligation transaction to indicate, through the reconciliation, a validation of the actual credit card purchase transaction with the single purchase limit and the set of internal credit limits;
cause electronic enforcement of the single purchase limit and the set of internal credit limits for the actual credit card purchase transaction by the computer system independent of the external credit card provider system, and
process the actual credit card transaction to the authorized budget account codes to return the spending actuals at the transaction level and aggregated for the financial system, or
where hybrid ledger level designation occurs, separating the individual actual ledger level transactions based on identification by an authorized user of the first group to allow immediate payment or require reconciliation prior to payment processing, after which each subset of actual ledger level transactions is processed for payment.
